(19) United States
(12) Patent Application Publication
(10) Pub. No.: US 2004/0247742 A1
(43) Pub. Date: Dec. 9, 2004

(54) Chewing gum compositions

(76) Inventors: Lynton Alexander Bridger, Whangaparoa (NZ); Adrian Stewart Denham Kerr, Auckland (NZ); Jean-Pierre Ghislain Dufour, Dunedin (NZ); Patrick Joseph Silcock, Dunedin (NZ); Stephanie Therese Vincent, Trenthcan Upper Hutt (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/485,246

(22) PCT Filed: Aug. 1, 2002
(86) PCT No.: PCT/NZ02/00145

(30) Foreign Application Priority Data
Aug. 1, 2001 (NZ) 513310
Aug. 1, 2001 (NZ) 513311

(51) Int. Cl. A23G 3/30

(52) U.S. Cl. 426/3

(57) ABSTRACT

The invention relates to chewable gum base compositions, to chewing gums containing them, and to processes for preparing them. The gum base composition comprises a blend of four to six casein products in a polyvinylacetate matrix. Also provided are processes for preparing casein products in the gum base composition.

### FIELD OF THE INVENTION

This invention relates to new chewable gum base compositions containing caseins, and processes for preparing same.

### BACKGROUND OF THE INVENTION

Chewing gums other than natural rubber gums are extremely complex food products. A fine balance of ingredients is required to produce a gum with desired properties of texture, mouth feel, tack over time during chew, saliva uptake and release, flavour and flavour release rates, controlled volume shrinkage, biodegradability, shelf stability, and low adhesion while still being cost effective to produce.

A recent promising innovation has been the development of gum bases containing casein, modified casein, or mixtures of both (WO 00/05972 and WO 01/54512). However, there is significant variation in the properties of casein and modified caseins, and as a result their effects on the properties of gum compositions in which they are incorporated. The wrong balance of these caseins can result in products with poor mouth feel, texture, cohesion and “off” flavours. Accordingly, there is still a need for a gum base composition which addresses these problems and achieves the desired properties identified above.

The present invention provides a gum base composition which goes some way towards meeting the above desiderata, or at least provides the public with a useful choice.

The invention further provides processes for producing caseins, useful in the compositions of the invention or again at least provides a useful choice to the public.

### SUMMARY OF THE INVENTION

In one aspect, the present invention therefore provides a gum base composition comprising a polycasein blend of at least four casein products selected from:

(a) transglutaminase treated non-gelled sodium caseinate;

(b) transglutaminase treated non-gelled isoelectric acid casein;

(c) transglutaminase treated, hydrolysed sodium caseinate;

(d) ultra fine mesh acid casein;

(e) fine mesh acid casein; and

(f) standard mesh acid casein.

Preferably, the polycasein blend comprises four to six, and more preferably five casein products selected from (a) to (f) above.

One of the four to six casein products is preferably (f).

Preferably, one of the other casein products is (b) or (e).

In one embodiment, the polycasein blend comprises the four casein products (a), (b), (d) and (f).

In another embodiment, the polycasein blend comprises the four casein products (a), (d), (e) and (f).

In a preferred embodiment, the polycasein blend comprises the five casein products (a), (b), (d), (e) and (f).

In this preferred embodiment each of the casein products is desirably present in an amount of from about 10% to 40% by weight of the polycasein blend.

The polycasein blend preferably comprises about 5 to 30% by weight, more preferably about 11 to 15% by weight, of the gum base composition.

The gum base composition of the invention further comprises an additional component which provides substance and extensibility. This. component is provided by polyvinylacetate. It is particularly preferred that the polyvinylacetate comprises a blend of polyvinyl acetates having differing molecular weights.

In addition, the gum base composition preferably includes one or more non-toxic plasticisers and/or emulsifiers. Preferably, the gum base includes mono- and di-glycerides esterified with mono-acetyl and di-acetyl tartaric acid (Datem), acetylated mono- and/or diglycerides, polyglycerol polyricinoleate one or more sugar esters, and/or mixtures thereof.

In a particularly preferred embodiment, the gum base composition further includes the additional emulsifiers lecithin and sodium stearoyl-2 lactylate or calcium stearoyl-2-lactylate.

It is also preferred that the gum base composition includes a texturiser, usually calcium chloride, which is conveniently combined with the polycasein blend prior to formulation of the gum base.

The gum base composition preferably also includes a filler such as talc.

In a further aspect, the present invention provides a chewing gum containing a chewable gum base composition as defined above.

In a preferred embodiment, the chewing gum further comprises glycerol triacetate (Triacetin), and/or stearic acid in combination with one or more sweeteners and/or flavouring agents.

In another aspect, the invention provides a confectionary product containing a chewable gum base composition as defined above.

In a further aspect, the invention provides a method for producing transglutaminase treated sodium caseinate and/or acid casein, the method comprising:

(1) solubilising curd to produce a caseinate;

(2) heating the caseinate;

(3) cooling (if required);

(4) incubating the caseinate at from ambient temperature up to about 55° C. with transglutaminase;

(5) quenching the transglutaminase reaction at about 55 to about 70° C., or using a volume of water sufficient to achieve a quench temperature of about 50° C. to about 80° C., the water being at about 50° C. to 100° C.;

(6) drying; and optionally

(7) grinding.

In one embodiment, the method further comprises the steps of adjusting the pH of the quenched caseinate to its isolectric point of pH 4.6 before drying.

Preferably, the method further comprises diafiltration of the quenched caseinate. It is also preferred that the diafiltered caseinate then be ultrafiltered.

The invention also provides acid casein, and transglutaminase treated casein when produced by the processes of the invention.

While the invention is broadly as defined above, it will be appreciated by those persons skilled in the art that it is not limited thereto but that it also includes embodiments of which the following description provides examples.

### DETAILED DESCRIPTION OF THE INVENTION

Accordingly, in a first aspect the invention relates to a gum base composition comprising a polycasein blend of at least four to six, and preferably five casein products. These products are selected from transglutaminase treated non-gelled sodium caseinate (MP1), transglutaminase treated non-gelled isoelectric acid casein (MP2), transglutaminase treated hydrolysed sodium caseinate (MP3), ultra fine mesh acid casein (MP4), fine mesh acid casein (MP5), and standard mesh acid casein (MP6).

The abbreviation “MP” as used herein refers to casein “milk proteins”.

“Ultra fine mesh” as used herein refers to a product wherein the casein particle size is less than about 10 microns. “Fine mesh” as used herein refers to a product wherein the average casein particle size is about 50-70 microns. “Standard mesh” as used herein refers to a product wherein a minimum of 99% of the casein particles must pass through a 250 micron sieve and 85% to 99% must pass through a 180 micron sieve. Measurements for ultra fine and fine mesh are as determined by Malvern Master Sizer.

Where four casein products are employed in the blend, these may be MP1, MP2, MP4 and MP6 present in an amount from about 3 to 25%, 10 to 30%, 13 to 35% and 13 to 35% by weight of the blend respectively. In one preferred embodiment the MP's are present in the blend in the following percentages: MP1 about 15%, MP2 about 25%, MP4 about 30%, MP6 about 30% by weight of the blend.

An alternative blend of four casein products comprises MP1, MP4, MP5 and MP6 in from about 5 to 30%, 13 to 35%, 5 to 35% and 13 to 45% by weight of the blend respectively. In one preferred embodiment, the MP's are present in the following percentages: MP1 25%, MP4, 20%, MP5 20%, MP6 35% by weight of the blend.

A preferred 6 casein blend comprises MP 1, MP2, MP3, MP4, MP5 and MP6 in amounts from about 5 to 25%, 10 to 30%, 2 to 15%, 13 to 35%, 5 to 35% and 13 to 45% by weight of the blend respectively. In one embodiment, the caseins are present in the blend in the following percentages: MP1 about 15%, MP2 about 20%, MP3 about 5.00%, MP4 about 17.5%, MP5 about 25%, and MP6 about 17.5% by weight of the blend.

The currently preferred polycasein blend comprises MP1, MP2, MP4, MP5 and MP6, each present in an amount of from about 10% to 30% by weight of the blend. Preferably, MP's 1 and 2 are present in an amount of from about 15% to 25%, and more preferably 20%. MP's 4 and 6 are present in an amount of from about 12% to 22%, more preferably 17% to 18%. MP5 is present in an amount of from about 20% to 30%, more preferably 25%.

It is also currently preferred that any polycasein blend include MP2 and/or MP5.

The polycasein blend preferably comprises from about 5 to 30% by weight of the gum base composition, more preferably about 11 to 15% by weight of the gum base composition.

In one embodiment, the gum composition comprising the polycasein blend forms a premix either per se or with a number of other ingredients discussed below.

The applicant's have surprisingly found that a gum base composition produced using these polycasein blends have good mouth feel, texture, chewing properties, and cohesion. The gum compositions also still exhibit favourable biodegradability and adhesion properties.

In particular, the applicant's have found that the chewing properties of a water absorbing gum can be modulated by the careful selection of the MPs. The MPs role is related to the gum bulkiness, the hardness and rubberiness of the gum, the length of chew and the cohesive quality.

The casein blend has been experimentally selected to provide optimum chewing. Without wishing to be bound by theory, the role of the casein blend in the gum is thought to be that the casein helps simulate the multiple phase nature of conventional gum (in a gum that is otherwise probably biphasic). The casein polymers partition between the solid phase as highly aggregated discrete particles, and the aqueous phase. Rather than providing the functional properties associated with the polyvinyl acetate the casein appears to more closely mimic the functional properties of the polyisobutylenes and butylated rubbers. The casein blend appears to impart a degree of rubberiness to the gum and helps even out and slow the textural changes the gum undergoes on chewing.

Though the casein powder does not appear to possess rubber-like properties as the casein absorbs water the properties of the casein are transformed. The combination of acid casein particle size and molecular weight distribution has been selected to give a consistent development of chewing properties in combination with a smooth texture.

More specifically, the MPs work by modulating the amount of moisture the gum absorbs; the rate that the gum absorbs moisture; and the amount of moisture retained in the gum. This is achieved through variation in particle size, variation in solubility and variation in water absorption capacity. Large casein particles (like MP6) absorb moisture slowly and in the presence of shear and the buffering capacity of the saliva slowly solubilise. This results in a gum that maintains good chewing characteristics throughout the length of the chew except between 3 and 5 minutes, but is too grainy.

Small casein particles (like MP4 and MP5) due to their increased surface area to volume ratio absorb water faster and solubilise faster. The result is a gum that becomes too soft and “sloppy”, releases the flavour unevenly and quickly becomes small, hard and less pleasant to chew than previous but the gum is substantially smoother.

Though MP1 and MP2 are largely small particles their solubility and water absorbing properties have been modified. MP2, in particular, is largely insoluble at pH7 and highly water absorbent. Due to this the MP2 behaves closer to MP6 than MP4 or MP5 but due to its high moisture absorbing capacity its sole use in a gum results in a watery gum that lacks life. MP1 contains a portion that is freely soluble at pH7, a portion that is sparingly soluble and an insoluble portion. It combines the attributes of MP2 with good emulsifying properties. Gums containing just MP1 as the casein portion will disintegrate/dissolve after about 10 minutes chewing.

A soluble highly crosslinked protein like MP3 aids in the emulsifying properties, though if used as the sole source of casein in the gum it will quickly become small, hard and is less pleasant to chew.

Since flavours have a major impact on the chewing characteristics of the gums varying the portions of the MPs will alleviate these textural changes. For example, a water-soluble flavour may require more MP2.

The properties of the MPs in the gum are not only important for chewing but also for removal.

To achieve the full rubberiness inherent in casein the MPs need to be fully hydrated. The different water absorbing properties of each MP discussed above smooth out texture changes that are experienced on chewing and result in slower and less extreme changes in texture resulting in better quality chewing characteristics. This is achieved by balancing the particle size and the water binding capacity of the different MPs—the smaller the particle the faster it absorbs water and by judicious cross-linking of the protein the rate and amount of water absorbed can be changed. It is important to keep the amount of MP6 as low as possible to produce a gum with a smooth texture, however, MP6's presence is required to maintain optimum water absorbing properties.

The chewing properties of the gum are further moderated by the slow solubilisation of the MPs with time and shear (i.e. chewing)—again this loss is mediated by particle size.

MP6 tends to give the best overall chewing properties when used in the formulations of WO 00/05972 however the gum is too grainy. Replacing MP6 with only MP4 and MP5 results in a gum that undergoes a large variation in hardness and rubberiness, and possesses a relatively short pleasurable chew time (5-10 minutes) due to the formation of a small, hard cud. The addition of MP1 and MP2 improve the cohesive quality, smooth out the variation in hardness and rubberiness and contribute a “bulkiness” to the gum.

Overall, the best chewing properties are achieved using a blend of four to six MPs rather than just a single MP, or blends of two or three MPs.

MP2 and/or MP5 have been identified as particularly important in achieving a well balanced gum formulation. For this reason, preferred gum formulations with four MP's are:

MP1, MP2, MP4 and MP6 and

MP1, MP4, MP5 and MP6; and with five MPs are:

MP1, MP2, MP4, MP5 and MP6.

The gum base composition additionally includes a component which provides substance and extensibility. This role is carried out by polyvinylacetate. Polyvinylacetate may be employed in the amounts and combination discussed in WO 00/05972. Preferably, a combination of 3 to 5 polyvinylacetates selected from those having molecular weights of approximately: (1) 12,900; (2) 14,000; (3) 25,000; (4) 40,000; and (5) 70,000-83,000 is used. For two polyvinylacetate blends (1) or (2) at up to about 40% by weight of the gum base composition and (4) at up to 30% by weight of the composition are preferred for use. For three polyvinylacetate blends (1), (3) and (4), or (1), (2) and (4), or (1), (3) and (5) are preferred for use, with (1) and (2), or (1) and (3) at up to 30%, and (4) or (5) at up to 20% by weight of the composition. For four polyvinylacetate blends (1) to (4) are used in the ranges from 1 to 25% by weight of the composition. In a particularly preferred embodiment all five polyvinylacetates are used in ranges from 1 to 20% by weight of the gum base composition. Usual ranges for the four and five polyvinlyacetate blends are: (1) up to about 25% by weight; (2) up to about 25% by weight; (3) about 8-25% by weight; (4) about 5 to 18% by weight; and (5) about 1 to 5% by weight.

Preparation of Casein Products

MP's, 4, 5 and 6 may be simply produced by drying and grinding lactic acid curd to a desired particle size. Alternatively, they may be produced by solubilising curd (lactic acid or mineral acid casein) under alkaline conditions to produce a caseinate, altering the pH to its isoelectric point of 4.6 and drying and grinding the product to achieve caseins of required particle size. The curd used as the starting material may be fresh, frozen, or dried. The curd may be produced from milk according to known art techniques.

In a preferred method, MP's 4, 5 and 6 are produced from lactic acid casein curd as follows:

Dried casein or de-watered casein curd is suspended in water (to give about 5-10% total solids) and the pH adjusted to between 7.0 and 8.5 and heated to 50° C. until dissolved. The solution is cooled to approximately 5° C. and diafiltered (approximately 4 to 6 theoretical volume changes). The pH is adjusted to 4.6 with hydrochloric acid, heated to 50° C. and filtered. The recovered curd is dried (eg freeze dried) and ground to the desired particle size. Grinding may be achieved according to known art techniques such as attrition, cryogenic or jet milling.

The term “diafiltration” as used herein refers to filtration of a caseinate solution through a semi-permeable membrane while diluting the solution but maintaining a constant volume, allowing small molecular weight molecules to pass out through the membrane.

Using the diafiltered acid product it has been determined that the casein product can be fluid bed, ring or spray dried. The products also exhibit less heat damage where gentler drying techniques can be employed than those known in the art.

The diafiltration step has also proved particularly important in obtaining a product with good flavour. The flavour and odour of casein and caseinate products is distinctive (especially those manufactured from milk derived from pasture fed cows and casein made using the lactic ferment process). These “off” flavours are often described as redolent of must, barn, milk, cow, burnt feathers, grass, and glue. Flavour reduction is therefore important when casein is to be used to produce a neutral flavoured gum base.

Without wishing to be bound by theory, it is believed that the above flavour improvement process removes a number of volatile compounds including o-aminoacetophone, o-cresol, p-cresol, 2 phenolethanol, indole acetophenone and benzaldehyde. Certain fatty acids and low molecular weight materials are also removed.

Transglutaminase treated, hydrolysed sodium caseinate (MP3) may be produced according to the process set out in WO 00/05972 or WO 01/54512, incorporated herein by reference.

The invention also provides a method for producing transglutaminase treated, hydrolysed sodium caseinate (MP3) phosphoprotein, the method comprising the step of polymerising a partial hydrolysate of casein or a caseinate.

Preferably, the partial hydrolysate of casein or a caseinate is obtainable by enzymatic hydrolysis. Suitable enzymes may be selected from the group consisting of trypsin, pepsin, chymotrypsin, and thermolysin. Preferably, the enzyme is porcine pancreatic trypsin.

The pH selected for hydrolysis will be determined by the enzyme selected for use. The partial hydrolysis is usually carried out at a pH from about 7 to about 8.

Conveniently, the polymerisation is carried out using at least about 0.21 mg of transglutaminase per dry gram of casein hydrolysate, for an incubation period of about 2 to about 56 hours, and at a pH of from about 7 to about 8.

Conveniently, the polymerisation reaction is terminated (quenched) by heating to a temperature sufficient to denature the enzyme.

Preferably, following termination of the polymerisation, the reaction mixture is dialysed or diafiltered to remove low molecular weight material, preferably using a membrane with a molecular weight cut off of 10,000 to 14,000.

The polymerisation, incubation and quenching steps may conveniently be the same as those set out for MP1 below with the exception that the incubation is terminated at a set time between 1 and 55 hours preferably 24 to 48 hours, depending on the required molecular weight of the final product.

Transglutaminase treated sodium caseinate (MP1) may also be produced according to the polymerisation method of WO 00/05972 or WO 01/54512. However, in an alternate new method developed by the applicant, MP1 is produced by solubilising 15% casein on a solids basis, fresh, frozen or dried, but preferably fresh, in a base. Sodium hydroxide is a convenient base, but carbonate bases, and buffers may equally be used. The pH should be in the range 7 to 8.2, and the casein concentration is diluted to approximately 2 to 13, preferably 5 to 8%. If frozen casein is used and particle size reduction is desired, then milling may be employed at this stage. The casein is then optionally preincubated at 30° C. to 100° C., preferably 50° C. to 70° C. to facilitate solubilisation. The preincubation step when used will generally be for about 5 to 120 minutes, preferably 60 minutes. The solubilised casein is then cooled if necessary to incubation temperature prior to addition of transglutaminase. The enzyme is added in the range 2 to 10 units of enzyme per gram of casein (activity determined using hydroxamate assay), preferably 4 to 7 units per gram of casein. The enzyme mix is then incubated at 30° C. to 55° C., preferably 45° C. to 50° C. for 1 to 5 hours to reach a viscosity of between 100 and 400 centipoise, preferably about 150 centipoise at 45° C. The transglutaminase reaction is then quenched by heating at about 53° C. to about 70° C., preferably about 60° C. and immediately cooling or diluting with a volume of water sufficient to achieve a quench temperature of about 50° C. to about 80° C., the water being at about 50° C. to 100° C. equal volume of hot water (about 50° to 100° C.) and heating to 50° C. to 80° C., preferably 60° C. The polymerised casein is then cooled, dried and ground as. required to produce MP1.

In a preferred embodiment, the quenched polymerised casein is subjected to diafilteration for the same reasons and with the same results as the diafiltration step discussed above. In particular, impurities such as lactose fatty acids, whey protein fragments, small peptides, and Maillard reaction components can be removed, and the flavour of the product produced is more neutral. Preferably, diafiltration is followed by an ultrafiltration step to concentrate the casein. Dewatering then further concentrates the solution. MP2 may be produced by a modification of that method where following the heating step, the casein is diafiltered or dialysed, and subsequently treated with acid to bring it to its isoelectric point of pH 4.6. Where diafiltration and/or ultrafiltration are employed acid treatment is effected after these steps. The isoelectric casein is then dried and ground as required. In a modified method, bacterial transglutaminase is used in preference to guinea pig transglutaminase. The process may also be carried out without the use of one or all of buffer, dithiotheritol, calcium and glycerol. This simplified process and superior caseins produced represent an improvement on the processes in WO 00/05972. There is an associated safety benefit in not using dithiothreitol.

For the avoidance of doubt, the term “casein”, as used herein refers to acid casein. Rennet casein, which is also a highly aggregated particulate protein, may be processed and used as an alternative to acid casein.

It is also generally preferred that a texturising agent which interacts with the casein is included to further crosslink and limit the casein solubility. Conveniently, the texturising agent is calcium chloride and/or carageenan. It is preferred that the texturiser is present in an amount of up to about 0.05 to 3.0% by weight of the total ingredients in the gum base formulation, more preferably about 0.8%-1.4% by weight. Other suitable calcium salts and divalent cations will be apparent to those skilled in the art.

The gum base formulation of the present invention also includes one or more emulsifiers and/or plasticizers. Suitable plasticizers and emulsifiers include mono- and di-glycerides esterified with mono-acetyl and di-acetyl tartaric acid (Datem), polyglycerol polyricinoleate, acetylated mono-and/or di-glycerides, sodium and calcium stearoyl-2-lactylate, lecithin, liquid acetylated monoglycerides, polysorbate 60, mono- and di-glycerides esterified with citric acid and mono- and di-glycerides esterified with lactic acid and sodium deoxycholic acid. It will be appreciated that these compounds may function as both emulsifiers and plasticizers for polyvinyl acetate.

It is preferred that the gum base of the present invention contains both polyglycerol polyricinoleate and Datem. It is more particularly preferred that the gum base contains the following combination of emulsifiers and plasticizers: (1) Datem, (2) acetylated mono and/or di-glycerides, and (3) polyglycerol polyricinoleate (PGPR), present in amounts of (1) from about 1 to about 15% by weight, more preferably from about 0.5 to about 10% by weight, (2) up to about 24% by weight, more preferably about 0.5 to about 8% by weight, and (3) from about 4.4 to about 20% by weight, more preferably about 6-11% by weight, respectively, of the gum base composition.

As an alternative to polyglycerol polycrinoleate, one or more sugar esters may be used in the same amount by weight, or a combination of sugar esters and PGPR can be used in the same amount by weight (i.e. 4.4 to 20%). Sugar esters currently preferred for use include those with HBL values below seven, for example sucrose eucate (ER-290), sucrose oleate, and sucrose stearate.

A preferred acetylated monoglyceride is that known as MYVACET 7-07™, which is produced from hydrogenated vegetable oil, has a melting point between 37° C. and 40° C. with a percent acetylation of between 66.5 and 69.5.

It is also particularly preferred that, in addition, the gum base formulation of the present invention includes both lecithin (preferably a lecithin with a relatively high solubility in acetone, such as that known as Emulpure N or Emulgum ™, which are deoiled soybean lecithins having a minimum phospholipid content of 95% and an acetone insoluble content of 95% minimum), present in amounts of up to about 6% by weight (more preferably about 1 to about 3% by weight), and sodium stearoyl-2-lactylate or calcium stearoyl-2-lactylate, present in amounts of up to about 5% by weight (more preferably about 0.5 to about 3% by weight) of the gum base composition.

The above combination of surfactants and plasticizers has been found to be particularly effective in plasticizing the polyvinyl acetate and maintaining an emulsion.

It is also preferred that the gum base of the invention includes a filler. The filler generally assists with processing and product texture. Examples of suitable fillers include talc, calcium carbonate, magnesium carbonate, alumina, tricalcium phosphate and synthetic or natural clay, and mixtures thereof. A preferred filler is talc. The amount of talc present should be effective to provide a cohesive gum base with good chewing properties. It is generally preferred that the filler is present in an amount of up to about 25% by weight, more preferably about 7-13% by weight, of the gum base composition.

Other components can also optionally be included in the gum base formulation if desired. These optional components included in the gum base are:

stearic acid at levels up to 3% by weight;

glycerol triacetate (Triacetin) at levels up to 15% by weight, preferably 2.2 to 7.3% by weight;

paraffin and micro-crystalline waxes at levels up to 5.0% by weight;

hardened fats at levels up to 2% by weight;

polycaprolactone (biodegradable polymer) at levels up to 3.0% by weight;

guar gum, at levels up to 0.5% by weight;

locust bean gum at levels up to 0.5% by weight; and

carrageenan at levels up to 2% by weight.

One preferred premix gum base composition comprises one or more polyvinylacetates, Myvacet 7-07™, Datem, a polycasein blend, paraffin and polycaprolacetone. Another premix composition comprises one or more polyvinylacetates, a polycasein blend, carrageenan and a texturising agent.

It is currently preferred to include stearic acid and Triacetin in the gum base composition rather than the gum.

Preparation of Chewable Gum Base Composition

The chewable gum base compositions of the invention contain the polycasein blend dispersed throughout a polyvinyl acetate matrix. The polyvinyl acetate matrix is present in the gum base as a continuous phase.

The gum base compositions of the present invention may be prepared by combining polyvinyl acetate with one or more plasticizers and/or emulsifiers suitable to plasticize the polyvinyl acetate, at a temperature sufficient to melt the polyvinyl acetate. It is generally preferred that the polyvinyl acetate be heated to a temperature of from about 55° C.-140° C., more preferably about 70° C.-110° C. The plasticizers/emulsifiers and polyvinyl acetate are preferably mixed until the polyvinyl acetate is molten and a homogeneous mixture is obtained.

The polycasein blend is also added to the composition, which is then mixed until visually homogeneous. It is preferred that the polycasein blend is added after the polyvinyl acetate is molten. The blend is preferably added in a dry form, and preferably, before adding it to the composition, the casein is first mixed with a texturising agent such as calcium chloride and/or carageenan.

It is generally preferred that, after the casein is added, the mixing is carried out with the composition at a lower temperature, preferably between 40-90° C. (to minimise heat damage to the casein particles and consequent possible production of off flavours). Once a homogeneous, cohesive mixture has been obtained, the resulting mass is preferably removed from the heat, and additional emulsifiers may be added, with slow mixing, preferably when the temperature of the mass reaches about 55° C. A filler may then be added slowly, preferably when the temperature of the base reaches between 40° C.-80° C., and the mass mixed until it is homogeneous.

The shear levels that can be used to mix the gum base are similar to those used to mix conventional gum bases known in the art. However, as the lower temperatures preferably used when mixing the casein into the composition will result in the composition becoming more viscous, higher shear levels may then be required to achieve adequate mixing.

In one preferred embodiment, a method of preparing a chewable gum base formulation of the present invention is as follows: A Brabender Plasticorder (W 50 mixer, cam blades) is used with an initial temperature of approximately 100° C., and an initial speed of approximately 60 RPM. The acetylated monoglycerides, sodium or calcium stearoyl-2-lactylate, Datem and paraffin (if used) and optionally stearic acid and Triacetin, are added first, followed immediately by the polyvinyl acetates, and the temperature is then reset to approximately 60° C. The polycasein blend and calcium chloride are added at approximately 3 minutes. The speed is decreased to approximately 40 RPM just before adding the polyglycerol polyricinoleate and lecithin at approximately 8 minutes. Lastly the filler (eg talc) is added at approximately 9 minutes, and mixing is stopped at approximately 10 minutes.

In another preferred embodiment, a method of preparing a chewable gum base formulation of the present invention is as follows: A Brabender Plasticorder (W 50 mixer, cam blades) is used with an initial temperature of approximately 100° C., and an initial speed of approximately 60 RPM. The acetylated monoglycerides, sodium or calcium stearoyl-2-lactylate, Datem and paraffin (if used) are added first, followed immediately by the polyvinyl acetates, and the temperature is then reset to approximately 40° C. The speed is decreased to 40 RPM at 4 minutes. The polyglycerol polyricinoleate or sugar esters and lecithin are added at approximately 7 minutes and the filler (eg talc) is added at 8 minutes. The casein and calcium chloride are added at approximately 9 minutes and mixing stopped at 11 minutes. The gum base temperature is approximately 70° C. when the casein and calcium chloride are added and approximately 72° C. when the mixer is stopped.

In the resulting gum base, the polyvinyl acetate forms the continuous, plasticized phase, throughout which individual particles of the casein/modified casein are dispersed.

Preparation of Chewing Gum

Chewing gums according to the invention can be prepared from the chewable gum bases described herein using conventional processes known in the art. These generally involve adding one or more sweeteners and/or flavouring agents to the gum base. Preferably, the sweetners and/or flavouring agents are in an amount of from about 10 to 85% by weight of the chewing gum, preferably 50 to 70% by weight. The chewable gum base formulations of the present invention are suitable for making into either sugarless chewing gums or sugar-containing chewing gums.

The chewing gums of the invention preferably contain the gum base in an amount from about 15% to about 90% by weight, more preferably about 20% to about 50% by weight and still more preferably about 24% to 35% by weight of the chewing gum.

In one embodiment, a chewing gum of the invention is prepared by melting the gum base with a liquid sweetener, conveniently glucose or Lycasin syrup, at a temperature of from about 45° C. to 65° C., accompanied by mixing. This is followed by the incremental addition of small amounts of a further sweetener in solid form, conveniently glucose powder or powdered sucrose, and flavouring agents. The reduced moisture content has been found to reduce stickiness and improve the chewing properties of the resulting gum.

Alternatively, the chewing gum of the invention may be prepared by incorporating the sweeteners and flavourings in the gum base using a suitable mixer. For example, a Brabender Plasticorder, fitted with a W 50 mixer (cam blades) and operated at a temperature of about 45° C. and a speed of 50 RPM can be used to produce a chewing gum according to the following steps:

1. The gum base and syrup are mixed for 2 minutes;

2. 33% of the powdered sucrose is added, and mixed for 2 minutes;

3. 33% of the powdered sucrose is added with 50% of the flavours, and mixed for 3 minutes;

4. 33% of the powdered sucrose is added with 50% of the flavours, and mixed for 2 minutes; and

5. The gum mass is removed from the mixer and rolled to a thickness of 2-3 mm.

In one embodiment, the additional components glycerol triacetate (preferably in an amount of from about 0.5 to 4%, more preferably about 0.75% to 2.5% by weight of the final chewing gum) and stearic acid (preferably in an amount of from about 0.2% to 1.5% by weight of the chewing gum) are also included into the chewing gum. The combination of glycerol triacetate and stearic acid has been found to improve the cohesion properties of the resulting chewing gum. Where glycerol triacetate and/or stearic acid are included, these are preferably added in step 1 of the above method.

In an alternate embodiment, glycerol triacetate and stearic acid may be included in the gum base composition as noted above.

The invention will now be further described with reference to the following non-limiting examples.

### EXAMPLES

### Example 1

| Ingredient | %(weight/weight) |
|---|---|
| Polyvinyl acetate (about 12.9 kDa) | 15.27 |
| Polyvinyl acetate (about 14 kDa) | 8.15 |
| Polyvinyl acetate (about 25 kDa) | 13.06 |
| Polyvinyl acetate (about 40 kDa) | 14.69 |
| Talc | 9.91 |
| carageenan | 0.76 |
| Datem | 3.29 |
| Acetylated monoglycerides | 2.25 |
| calcium stearoyl lactate | 0.27 |
| acid casein (MP6) | 2.29 |
| sub-10 μm acid casein (MP4) | 2.31 |
| Calcium chloride | 0.55 |
| Lecithin | 2.02 |
| polyglycerolpolyricinoelate | 9.89 |
| parafin wax | 1.00 |
| Stearic acid | 1.16 |
| Antioxidant | 0.03 |
| Polyvinyl acetate (83 kDa) | 1.82 |
| acid casein (MP5) | 3.29 |
| casein (MP1) | 5.26 |
| polycaprolactone | 2.73 |
| | 100.0 |

Method of Preparation of Gum Base

A gum base was prepared having the above formulation using the following method: A Brabender Plasticorder (W 50 mixer, cam blades) was used, with an initial temperature of 100° C., and an initial speed of 60 RPM. The acetylated monoglycerides, sodium stearoyl-2-lactylate and datem were added, followed immediately by the polyvinyl acetate. The temperature was then reset to 60° C. The casein and calcium chloride were added at 3 minutes. The speed was decreased to 40 RPM just before adding the polyglycerol polyricinoleate and lecithin at 8 minutes. The talc was added at 9 minutes and mixing stopped at 10 minutes.

Method of Preparation of Chewing Gum

Chewing gums having the following formulation were prepared from the gum base compositions:

| Ingredient | % (weight/weight) |
|---|---|
| gum base | 31.9 |
| lycasin syrup | 15.5 |
| powdered sorbitol | 41.6 |
| mannitol | 7.4 |
| flavour | 1.4 |
| acelsulfame K (non-capsulated) | 0.2 |
| Triacetin | 2.0 |
| | 100.00 |

The chewing gum was prepared using a Brabender Plasticorder fitted with a W50 mixer (cam blades). Temperature set at 45° C. and mixer speed at 50 RPM.

The chewing gum was produced in 3 steps:

1. Gum base, glycerol triacetate, lycasin syrup, mannitol and glycerol (if included in formulation) were added to the mixer and mixed for 3 minutes;

2. The powdered sorbitol, acesulfame K and flavour were added, mixed for 3 minutes;

3. The gum mass was removed from the mixer and put through a set of rollers so a product thickness of 3 mm were obtained.

The gum when chewed for 5 minutes absorbed about 51% (dry basis) but can absorb up to 100% on soaking in water. In a trial, this gum was chewed for 5 minutes then weighed and dried at 80° C. until a constant weight was achieved. Data observed was as follows:

| | Initial | | | | | |
|---|---|---|---|---|---|---|
| Time | gum | wet | dry | % moisture | % solids | % protein |
| chewed | weight | cud | cud | absorbed | lost | of solids |
| 5 minutes | 3.046 | 2.280 | 1.508 | 51.4 | 50.5 | 8.8 |

### Example 2

| Ingredient | %(weight/weight) |
|---|---|
| Polyvinyl acetate (about 12.9 kDa) | 15.27 |
| Polyvinyl acetate (about 14 kDa) | 8.15 |
| Polyvinyl acetate (about 25 kDa) | 13.06 |
| Polyvinyl acetate (about 40 kDa) | 16.51 |
| Talc | 12.62 |
| carageenan | 0.76 |
| Datem | 3.29 |
| Acetylated monoglycerides | 2.25 |
| calcium stearoyl lactate | 0.27 |
| acid casein (MP6) | 4.89 |
| sub-10 μm acid casein (MP4) | 4.98 |
| Calcium chloride | 0.55 |
| Lecithin | 2.02 |
| polyglycerolpolyricinoelate | 9.89 |
| parafin wax | 1.00 |
| Stearic acid | 1.16 |
| Antioxidant | 0.03 |
| Polyvinyl acetate (83 kDa) | — |
| acid casein (MP5) | — |
| casein (MP1) | 3.29 |
| polycaprolactone | — |
| | 100.00 |

The gum when chewed for 20 minutes absorbed about 85% (dry basis) and 100% (dry basis) on soaking in water. In a trial, this gum was chewed for 20 minutes then weighed and dried at 80° C. until a constant weight was achieved. Data observed was as follows:

| | Initial | | | % | | |
|---|---|---|---|---|---|---|
| Time | gum | wet | dry | moisture | % solids | % protein |
| chewed | weight | cud | cud | absorbed | lost | of solids |
| 20 minutes | 3.641 | 1.722 | 0.930 | 85.2 | 74.5 | — |

### Examples 3 and 4

The formula for the KTL gums used in the following experiments was as follows:

| | Formulation A | Formulation B |
|---|---|---|
| Ingredient | %(weight/weight) | %(weight/weight) |
| Polyvinyl acetate (about 12.9 kDa) | 15.27 | 15.27 |
| Polyvinyl acetate (about 14 kDa) | 8.15 | 8.15 |
| Polyvinyl acetate (about 25 kDa) | 13.06 | 13.06 |
| Polyvinyl acetate (about 40 kDa) | 14.69 | 14.69 |
| Talc | 9.89 | 12.62 |
| carageenan | 0.76 | 0.76 |
| Datem | 3.29 | 3.29 |
| Acetylated monoglycerides | 2.25 | 2.25 |
| calcium stearoyl lactate | 0.27 | 0.27 |
| acid casein (MP6) | 4.89 | 4.89 |
| sub-10 μm acid casein (MP4) | 4.98 | 4.98 |
| Calcium chloride | 0.55 | 0.55 |
| Lecithin | 2.02 | 2.02 |
| polyglycerolpolyricinoelate | 9.89 | 9.89 |
| parafin wax | 1.00 | 1.00 |
| Stearic acid | 1.16 | 1.16 |
| Antioxidant | 0.03 | 0.03 |
| Polyvinyl acetate (83 kDa) | 1.82 | 1.82 |
| casein (MP1) | 3.29 | 3.29 |
| polycaprolactone | 2.73 | 0.00 |
| | 100.0 | 100.0 |

| | Formulation C |
|---|---|
| Ingredient | %(weight/weight) |
| Polyvinyl acetate (about 12.9 kDa) | 15.27 |
| Polyvinyl acetate (about 14 kDa) | 8.15 |
| Polyvinyl acetate (about 25 kDa) | 13.06 |
| Polyvinyl acetate (about 40 kDa) | 14.69 |
| Talc | 12.64 |
| carageenan | 0.76 |
| Datem | 3.29 |
| Acetylated monoglycerides | 2.25 |
| calcium stearoyl lactate | 0.27 |
| acid casein (MP6) | 2.29 |
| sub-10 μM acid casein (MP4) | 2.31 |
| Calcium chloride | 0.55 |
| Lecithin | 2.02 |
| polyglycerolpolyricinoelate | 9.89 |
| parafin wax | 1.00 |
| Stearic acid | 1.16 |
| Antioxidant | 0.03 |
| Polyvinyl acetate (83 kDa) | 1.82 |
| acid casein (MP5) | 3.29 |
| casein (MP1) | 2.63 |
| casein (MP2) | 2.63 |
| | 100.0 |

The gums were prepared in a similar manner to Example 1.

### Example 3

Scrubbing procedure:

1. The KTL gums (formulation A) were chewed for 30 minutes until the gum yield was approximately constant.

2. At end of chewing the gum cud weight was recorded, placed onto dry, brushed concrete paver and covered with a double layer of tin-foil/release paper. The pavers were labelled with date chewed, length of time to be covered with a paver, the gum code number and the name of the person who chewed the gum.

3. The gum was covered with a second dry, brushed paver placed so it covered at most 2 gums. The paver was pressed down so that the weight rested evenly on the two gums (to give an average weight per gum of 2.5 kg).

4. The paver stack was stored in a temperature-controlled room for 3 days (17±1° C., relative humidity 40%). The top paver was removed at either, 30 seconds, 30 minutes, 12 hours or 24 hours. The gums were further aged for either: 12 hours, 24 hours, or 32 hours.

5. The three cud-containing pavers were contained with wooden boxing to prevent movement during assessment.

6. The first set of runs with the Tennant 580 scrubbing machine fitted with abrasive bristled cylindrical brushes, the samples were pre-wet five minutes prior to removal using the Tennant 580 scrubbing machine fitted with polypropylene bristled brushes. The second set of runs used brushes with grit impregnated bristles. The bristles on the circular brushes were polypropylene (non-standard Tennant brushes).

7. The proportion of cud removed was assessed visually.

8. Gums removed on the 3 Aug. 2000.

Results

The proportion of gum removed by a Tennant 580 Scrubber from pavers after 4 passes

| | Percent of gum removed after a | | | |
|---|---|---|---|---|
| Time aged after | varying amount of compression time | | | |
| Compression | 30 seconds | 30 minutes | 12 hours | 24 hours |
| 12 hours | 100% | 95% | 90% | 95% |
| 24 hours | 100% | 60% | 70% | 90% |
| 32 hours | 100% | 50% | 50% | 70% |

The variation in removal success was mostly due to uneven paver height, reducing brush contact, and insufficient brush down pressure. The bottoms of the paving stones are not smooth and unfortunately the concrete floor the paving stones were sitting on was not level either. Both these factors caused the some paving stones to sit higher than some others and also resulted in them rocking when the scrubbing machine ran other them. Interestingly the cuds removed first were ones that were smeared on the paver—these cuds are typically well adhered and slower to remove by water blasting. The remaining cud, if about 5% to 20% of original cud size, could be scuffed off with a shoe.

The circular brush (polypropylene bristles) removed up to approximately 60% of the cuds depending on the quality of brush contact with the brush. Again brush down pressure appeared variable. The surface had become very uneven due to a large number of broken paving stones. A firmer brush may have proven more successful.

### Example 4

Removal Trials Using Tennant 5700 and 7400 Scrubbers

1. Washed or chewed cuds were deposited comprising KTL gum (formulation C) cuds, and conventional commercially available gums. Three lanes were marked out, with each lane was independent from the others with Day 7 cuds at one end leading down to Day 1 at the other.

2. All cuds (apart from Day 7) were covered with a non-absorbing cover sheet, a standard paving brick placed on top which was then stood on for approximately 10 seconds. Compression accounted for 35% of the total deposition time after which the foil cover sheet was carefully removed and the cud exposed to the environment. Due to unforeseen circumstances Day 7 cuds were reduced in number by 38%—these were not covered with foil and they were roughly compressed.

3. Cuds were chewed for a minimum of 10 minutes and all washed cuds were exposed to cold water washing for 24 hours followed by 5 minutes hand washing in warm water (to simulate chewing).

4. Two standard Tennant machines were selected for trial—a 5700 walk behind power scrubber and a ride on 7400 scrubber (with co-rotating cylindrical brushes).

Lane 1. A 5700 with 2 abrasive bristled disc brushes, travelling at 3 m/min immediately followed by a 7400 with two 2 abrasive bristled co-rotating cylinder brushes with a 10 minute pre-wet with detergent.

Lane 2. A 5700 with 2 polypropylene bristled disc brushes, travelling at 3 m/min immediately followed by a 7400 with two 2 abrasive bristled co-rotating cylinder brushes running with minimal water and no pre-wetting.

Lane 3. A 5700 with 2 abrasive bristled disc brushes, travelling at 3 m/min immediately followed by a 7400 with two 2 abrasive bristled co-rotating cylinder brushes with a 45 minute pre-wet with detergent.

Results
Lane 1. 10 minute Pre-Soak

| | Number of | Amount of cud | | | Amount of cud |
|---|---|---|---|---|---|
| Cud Code | cuds | removed (%) | Cud Code | Number of cuds | removed (%) |
| | 1 | 0 | K1 | 3 | 100 |
| X1C | 1 | 0 | K2 | 3 | 100 |
| X1 | 3 | 3 | K3 | 3 | 100 |
| Y2C | 1 | 0 | K4 | 3 | 80 |
| X2C | 2 | 5 | K5 | 3 | 95 |
| X2 | 2 | 0 | K6 | 3 | 50 |
| X3C | 1 | 0 | | | |
| X3 | 2 | 5 | | | |
| X4C | 1 | 0 | | | |
| X4 | 1 | 0 | | | |
| Y5C | 1 | 0 | | | |
| X5 | 3 | 0 | | | |
| X6 | 3 | 0 | | | |

Lane 2. No pre-wetting

| | Number | Amount of cud | | Number of cuds | Amount of cud |
|---|---|---|---|---|---|
| Cud Code | of cuds | removed (%) | Cud Code | per code | removed (%) |
| Y1C | 1 | 0 | K1 | 5 | 100 |
| X1C | 2 | 0 | K2 | 3 | 100 |
| X1 | 3 | 5 | K3 | 3 | 63 |
| X2C | 3 | 0 | K4 | 3 | 30 |
| X2 | 3 | 6 | K5 | 3 | 53 |
| Y3C | 2 | 0 | K6 | 3 | 40 |
| X3C | 1 | 0 | K7 | 5 | 5 |
| X3 | 1 | 0 | | | |
| X4 | 3 | 0 | | | |
| X5 | 3 | 3 | | | |
| X6 | 3 | 10 | | | |
| X7 | 1 | 0 | | | |

Lane 3. 45 Minute Pre-Soak

| | Number | Amount of cud | | | Amount of cud |
|---|---|---|---|---|---|
| Cud Code | of cuds | removed (%) | Cud Code | Number of cuds | removed (%) |
| Y1C | 2 | 0 | K1 | 4 | 95 |
| X1C | 1 | 10 | K2 | 5 | 90 |
| X1 | 3 | 2 | K3 | 3 | 100 |
| X2C | 2 | 0 | K4 | 3 | 80 |
| X2 | 3 | 10 | K5 | 3 | 93 |
| Y3C | 1 | 0 | K6 | 3 | 90 |
| X3C | 3 | 0 | K7 | 3 | 5 |
| X4 | 2 | 5 | | | |
| X5 | 3 | 3 | | | |
| X6 | 3 | 2 | | | |
| X7 | 1 | 0 | | | |

wherein:

K is a KTL gum

X and Y are conventional commercially available gums

Number 1-7 Refers to the number of days the gum was adhered to the concrete; and C means the gum was chewed instead of being washed.

The results show even a 10-minute wait after pre-wetting can be useful in increasing the proportion of cuds removed from a concrete surface. However, a 45-minute wait starts to enable gum cuds that have been adhered for up to a week to be removed.

These examples demonstrate that gums with a blend of five casein products are more removable than conventional gums, and just as removable as gums containing a blend of three casein products.

### Example 5

In this example, a gum of the following formulation was used:

| Ingredient | %(weight/weight) |
|---|---|
| Polyvinyl acetate (12.9 kDa) | 14.40 |
| Polyvinyl acetate (14 kDa) | 7.68 |
| Polyvinyl acetate (25 kDa) | 12.31 |
| Polyvinyl acetate (40 kDa) | 13.85 |
| Talc | 15.60 |
| carageenan | 0.76 |
| Datem | 3.29 |
| Acetylated monoglycerides | 2.25 |
| calcium stearoyl lactate | 0.27 |
| acid casein (MP6) | 2.29 |
| sub 10 μm acid casein (MP4) | 2.31 |
| Calcium chloride | 0.54 |
| Lecithin | 2.02 |
| polyglycerolpolyricinoelate | 9.88 |
| parafin wax | 1.00 |
| Stearic acid | 1.16 |
| Antioxidant | 0.03 |
| Polyvinyl acetate (83 kDa) | 1.82 |
| acid casein (MP5) | 3.29 |
| polymerised caseinate (MP3) | 5.26 |
| | 100.00 |

The gum was prepared in a similar manner to Example 1.

A Tennant scrubbing machine was fitted with an abrasion disc brush. The samples were pressed onto dry pavers (4 samples per paver) and subjected to various conditions as listed below. The samples were wet then left for 10 minutes. During scrubbing, additional water was again sprayed onto samples. The scrubber made a single pass over the samples at approximately walking speed. The samples were rated from 1-5 (none-all) for amount of material removed. The samples were left for 20 minutes and the scrubbing process repeated. Again the samples were rated from 1-5 for material removed.

Sample Treatments:

| | |
|---|---|
| A | Two days |
| B | Four days (1) (wet at 2 days) |
| C | Four days (2) |
| D | Eight days (1) (wet at 4 days) |
| E | Eight days (2) (no water) |
| F | Sixteen days (1) (wet at 4, 8 and 12 days) |
| G | Sixteen days (2) (wet at 4 and 12 days) |
| H | Sixteen days (3) (no water) |

(P)-samples were pre-wet for an additional 20 minutes prior to commencement of the trial

1-less than 10% removed

5-greater than 95% removed

| | | | |
|---|---|---|---|
| 1 | 2 | 3 | 4 |

Results: (10 min wetting)

| | | | | |
|---|---|---|---|---|
| A | 4 | 5 | 5 | 5 |
| B | 4 | 4 | 4 | 4 |
| C | 2 | 3 | 4 | 2 |
| D | 3 | 2 | 1 | 2 |
| E | 2 | 1 | 2 | 3 |
| F | 2(P) | 2(P) | 2 | 2 |
| G | 2 | 2 | 2 | 2 |
| H | 2 | 3 | 3(P) | 2(P) |

Results (10 min + 20 min wetting)

| | | | | |
|---|---|---|---|---|
| A | 5 | 5 | 5 | 5 |
| B | 5 | 5 | 4 | 5 |
| C | 3 | 4 | 5 | 3 |
| D | 3 | 3 | 2 | 3 |
| E | 3 | 2 | 3 | 3 |
| F | 2(P) | 2(P) | 2 | 2 |
| G | 2 | 2 | 2 | 2 |
| H | 2 | 3 | 3(P) | 2(P) |

The samples were readily removed with a 10-minute wetting/scrubbing combination up to 2 days. A 20-minute wetting/scrubbing procedure increases this time to 8 days. Eight and sixteen day samples were difficult to re-hydrate and soften. However, even at 16 days with no weathering some product was being removed. The older cuds were being removed in layers as their surface rehydrated and softened.

The results show that gums with a blend of four caseins are also removable.

### Example 6

GUM BASE FORMULATION

| | BASE | |
|---|---|---|
| | Weight | |
| Ingredient | Grams | % |
| Polyvinylacetates 53% | | |
| 12.9 kDa | 8.400 | 15.3 |
| 14 kDa | 4.480 | 8.1 |
| 25 kDa | 7.180 | 13.1 |
| 83 kDa | 1.000 | 1.8 |
| 40 kDa | 8.080 | 14.7 |
| Talc | 5.450 | 9.9 |
| Carrageenan | 0.420 | 0.8 |
| Myvacet 7-07 | 1.240 | 2.3 |
| Datem (Lamegin - no Calcium Phosphate added) | 1.810 | 3.3 |
| Modified Milk Proteins 13% OR 20% of the Elastomers | | |
| MP 6 | 1.258 | 2.3 |
| MP 4 | 1.273 | 2.3 |
| MP 5 | 1.808 | 3.3 |
| MP 1 | 1.446 | 2.6 |
| MP 2 | 1.446 | 2.6 |
| Calcium Chloride | 0.300 | 0.5 |
| Calcium stearoyl-2-lactylate | 0.150 | 0.3 |
| Stearic Acid | 0.640 | 1.2 |
| Polyglycerol polyricinoleate | 5.440 | 9.9 |
| Lecithen Emulpure N | 1.110 | 2.0 |
| Paraffin | 0.550 | 1.0 |
| Sustane N BHA | 0.017 | 0.0 |
| Polycaprolactone | 1.500 | 2.7 |
| Base | 0.000 | 0.0 |
| TOTAL | 54.998 | 100.0 |

| Chewing Gum Formulation | % |
|---|---|
| Base (above) 20% of the Elastomers used are Milk | 31.9 |
| Proteins | |
| Lycasin Syrup (75% TS) | 15.5 |
| Powdered Sorbitol | 41.6 |
| Mannitol | 7.4 |
| Flavour | 1.4 |
| Acesulfame K (Non-encapsulated) | 0.2 |
| Triacetin | 2.0 |
| TOTAL | 100.0 |

The gum was prepared in a similar manner to Example 3.

### Example 7

The gum base composition in Example 7 may also be provided in the form of a premix as follows:

GUM BASE FORMULATION

| | Polycasein5 (PC5) & | |
|---|---|---|
| | Base | |
| | PC5 | Base |
| Ingredient | Grams | Grams |
| polyvinylacetates 53% | | |
| 12.9 kDa | | 8.400 |
| 14 kDa | 4.480 | |
| 25 kDa | | 7.180 |
| 83 kDa | | 1.000 |
| 40 kDa | | 8.080 |
| Talc | | 5.450 |
| Carrageenan | | 0.420 |
| Myvacet 7-07 | 1.240 | |
| Datem (Lamegin - no Calcium Phosphate added) | | 1.500 |
| Modified Milk Proteins 13% OR 20% of the | | |
| Elastomers | | |
| MP 6 | 1.258 | |
| MP 4 | 1.273 | |
| MP 5 | 1.808 | |
| MP 1 | 1.446 | |
| MP 2 | 1.446 | |
| Calcium Chloride | | 0.300 |
| Calcium stearoyl-2-lactylate | | 0.150 |
| Stearic Acid | | 0.640 |
| Polyglycerol polyricinoleate | | 5.440 |
| Lecithen Emulpure N | | 1.110 |
| Paraffin | 0.550 | |
| Sustane N BHA | | 0.017 |
| Polycaprolactone | 1.500 | |
| Base | | 16.501 |
| Total | 16.501 | 54.998 |
| Chewing Gum Formulation | | |
| Base (above) 20% of the Elastomers | | |
| used are Milk Proteins | | |
| Lycasin Syrup (75% TS) | | |
| Powdered Sorbitol | | |
| Mannitol | | |
| Flavour | | |
| Acesulfame K (Non-encapsulated) | | |
| Triacetin | | |
| TOTAL | | |

The ingredients in the left hand column form part of the premix. The ingredients in the right hand column may be added later when the gum base composition is being formulated.

### Example 8

This Example was designed to test the chewing properties of different gums.

The base formulation of the gums chewed was as below:

| | % (weight/weight) | | |
|---|---|---|---|
| | Examples | Example | |
| Ingredient | 1-4 | 5-8 | Example 9 |
| Polyvinyl acetate (about 12.9 kDa) | 15.27 | 14.36 | 8.15 |
| Polyvinyl acetate (about 14 kDa) | 8.15 | 7.66 | 15.28 |
| Polyvinyl acetate (about 25 kDa) | 13.06 | 12.28 | 13.06 |
| Polyvinyl acetate (about 40 kDa) | 14.69 | 13.82 | 16.51 |
| Talc | 12.62 | 11.88 | 10.83 |
| carageenan | 0.76 | 0.72 | 0.76 |
| Datem | 3.29 | 3.10 | 3.29 |
| Acetylated monoglycerides | 2.25 | 2.12 | 2.26 |
| Calcium stearoyl lactate | 0.27 | 0.26 | 1.28 |
| Calcium chloride | 0.55 | 0.51 | 0.54 |
| Lecithin | 2.02 | 1.90 | 2.02 |
| Polyglycerolpolyricinoelate | 9.89 | 9.30 | 8.46 |
| Parafin wax | 1.00 | 0.94 | 1.00 |
| Stearic acid | 1.16 | 1.09 | 1.16 |
| Antioxidant | 0.03 | 0.03 | 0.03 |
| Polyvinyl acetate (83 kDa) | 1.82 | 1.71 | — |
| Glycerol triacetate | — | 5.95 | — |
| Casein | 13.16 | 12.37 | 16.45 |
| | 100.0 | 100.0 | 101.08 |

Where the casein composition was sodium caseinate; standard particle sized casein; a blend of standard particle sized casein and ultra fine acid casein (49.7% and 50.3%, respectively); or polycasein 5 (MP's 1, 2, 4, 5 and 6) for examples 1-4. For examples 5-8 the casein composition was either: A (MP1 20%, MP2 20%, MP3 5%, MP4 17.5%, MP5 20% and MP6 17.5%); B (MP1 25%, MP4 20%, MP5 20% and MP6 35%); C (MP1 15%, MP2 25%, MP4 30% and MP5 30%); and D (MP1 15%, MP2 25%, MP4 30% and MP6 30%). For Example 9 the casein composition was as per Example 12 of WO 01/54512. That is MP3 6.58%, MP4 4.89% and MP6 4.98%.

The difference between examples 1-4 and 9, and examples 5-8 was that the glycerol triacetate was included in the base as opposed to addition to the chewing gum. The manufacturing process was as outlined in previous examples except that the glycerol triacetate was added to the mixer at the same time as the polyvinyl acetates for examples 5-8. The amount of glycerol triacetate added was equivalent to that added to the chewing gums for examples 1-4 and 9.

The chewing gum formulation was the same for all three bases and is outlined below.

| | % (weight/weight) | | |
|---|---|---|---|
| Ingredient | Examples 1-4 | Example 5-8 | Example 9 |
| Gum base | 31.92 | 33.94 | 31.74 |
| Maltitol syrup | 15.46 | 15.46 | 17.72 |
| Mannitol (powder) | 7.39 | 7.39 | 7.35 |
| sorbitol (powder) | 41.63 | 41.63 | 39.04 |
| Flavour | 1.41 | 1.41 | 1.40 |
| Acesulfame K | 0.17 | 0.17 | 0.75 |
| Glycerol triacetate | 2.02 | — | 2.00 |
| | 100.00 | 100.00 | 100.00 |

The chewing gums were prepared as outlined in the previous examples except that for examples 5-8 the gum bases were cut into small pieces and not ground.

The results below illustrate the effect of changing the casein type on the chewing quality of the finished chewing gum.

| | Rating out of ten | | | | | |
|---|---|---|---|---|---|---|
| | after minutes chewed | | | | Degree of | % Loss on |
| Casein composition | 0 to 1 | 1 to 5 | 5 to 10 | 10 to 20 | Smoothness* | Chewing |
| 1. Sodium caseinate | 9.4 | 6.7 | 5.5 | 6.7 | 4.96 | 61 |
| 2. Standard particle sized acid | 9.4 | 5.5 | 7.7 | 8.2 | 2.00 | 47 |
| casein | | | | | | |
| 4. Polycasein 5 | 9.4 | 8.3 | 7.9 | 8.2 | 4.50 | 48 |
| 5. A | 9.2 | 8.6 | 8.5 | 8.1 | 4.40 | 52 |
| 6. B | 9.2 | 8.6 | 8.6 | 8.0 | 4.50 | 53 |
| 7. C | 9.2 | 8.1 | 7.1 | 7.0 | 4.70 | 65 |
| 8. D | 9.1 | 8.4 | 8.3 | 7.6 | | |
| 3. Standard particle sized | 9.5 | 8.3 | 6 | | 4.20 | 33 |
| acid casein | | | | | | |
| and fine acid casein¹ | | | | | | |
| Ex9¹ | 9.2 | 7.9 | 7.9 | | 3.80 | 41 |

*Degree of smoothness was rated out of 5 (with 5 being smooth)
¹Ex 9 and the standard particle sized acid casein fine acid casein blend gums were only chewed for 10 minutes

The gums were chewed by two assessors who were expert at characterising the chewing properties of chewing gum. The assessment of the gums was split into four time periods (see below) and at the end of the period the performance was rated out of 10:

0 to 1 minute examining initial hardness, initial cohesive properties of the gum

1 to 5 minutes changes in texture, smoothness, presence of off-flavours/bitterness

5 to 10 minutes changes in texture, presence of off-flavours/bitterness

10 to 20 minutes changes in texture, presence of off-flavours/bitterness

With changes in texture the assessors were considering, the degree of change with respect to hardness and rubberiness, whether it is too hard/soft or too rubbery/lacking bounce. Also recorded was the time to loss of sweetness, time to loss of flavour, structure of gum at completion of chewing and loss on chewing (as an indication of final cud size). (For further description of the characteristics that were considered when assessing the gums the readers are directed to the following reference: Fritz D,. Chewing gum technology In Sugar Confectionery Manufacture. Jackson E. B., (Ed.), pages 259-286 (1995) (2nd edition).

All of the gums possessed good initial cohesion though the sodium caseinate were quite hard initially. From about 4 minutes the sodium caseinate gum became increasingly sloppy and soft (unacceptably so) until it firmed up suddenly at about 7 minutes.

The gum containing 80 mesh casein though possessing good initial cohesion and good initial chewing properties was unpleasant to chew due to the extremely grainy nature of the gum and the gum unpleasantly soft texture between 3 and 5 minutes. The casein finished absorbing moisture between 7 and 10 minutes with the texture becoming less grainy and the chewing properties improving.

The gum containing the standard particle sized acid casein and fine acid casein was smoother than the gum containing just the standard particle sized acid casein. It also possessed better chewing characteristics for the 1-5 minutes without the unpleasantly soft texture between 3 and 5 minutes. The gum was however too soft from 5 to 10 minutes.

The gum containing the polycasein 5 possessed good initial cohesion and good chewing characteristics without the sloppiness of that the previous gums possessed. The gum did not possess unpleasant grainy texture of the 80 mesh acid casein.

The gum containing casein blend A possessed a smooth texture and possessed good consistent chewing properties though to 10 minutes. The gum increased in rubberiness from about 13 minutes through to 20 minutes but was not unpleasant to chew. The presence of off-flavours was noted—the source of these was believed to be from the MP3.

The gum containing casein blend B possessed a smooth texture, possessed good consistent chewing properties though to 10 minutes and was slightly firmer than the casein blend A containing gum. The gum increased in rubberiness from about 13 minutes through to 20 to finish slightly firmer than the casein blend A containing gum.

The gum containing casein blend C chewed surprisingly badly compared to the casein blend D containing gum. The gum was too soft at 5 minutes and at about 7 minutes underwent a texture change at about 8 minutes. The gum became tough and hard by the end of 20 minutes.

The change of MP5 to MP6 had a huge impact on the chewing properties of the casein blend D gum. Though the gum was marginally grainier the gum did not undergo the texture change at about 8 minutes and retained a good rubbery chew through until 18 minutes. Though there was a slight toughening of the texture from 18 minutes The difference between casein blend C and D was surprising, as the only difference in the gum formulation was the difference in particle size between MP5 and MP6. The larger particle size slowed the rate of moisture absorption and resulted in a gum that underwent less extreme texture changes on chewing.

The gum of example 9 was slightly too variable in hardness for the first 5 minutes. From 5 minutes to 8 minutes the gum was too soft and was starting to harden and toughen by 10 minutes. We also expect that other polycasein blends with only three casein products present will prove similarly less desirable than the polycasein blends having four to six casein products.

### Example 10

Method of Manufacture of MP1 and MP2

Raw Materials Specification

Standard Lactic Acid Casein (from Curd)

Transglutaminase

| Items | Standard Values | Method/Remarks |
|---|---|---|
| Product Name | Activa MP | Supplied Ajinomoto |
| Appearance | Off white powder | |
| Loss on Drying | Less than 2% | At 80° C. for 2 hours |
| PH | 5.5-6.5 | 2% solution |
| Arsenic | Not more than 2 ppm | As As₈O₃ |
| Heavy Metals | Not more than 20 ppm | As Pb |
| Total Viable Counts | 1,000 cfu | AJI test |
| Heat Resistant Bacteria | 100 cfu | AJI test (100° C. for |
| | | 10 min |
| Coliforms | Negative | AJI test |

Sodium Hydroxide

Food Grade Sodium Hydroxide

Manufacturing Process

Incubation for MP1 and MP2

A 7.5% acid casein (dry basis) solution is prepared using sodium hydroxide to solubilise the casein (fresh curd, frozen curd or dry casein may be used) with a final pH between 7.5-8 and preincubated at 50° C. for 10 minutes. Sufficient 10% Activa MP transglutaminase solution is added so a final concentration of 4.5% enzyme powder to acid casein is achieved. (The Activa MP powder contains 1% transglutaminase with the remainder lactose and maltodextrin.) When the viscosity reaches the desired point (about 300 centipoise at 50° C.) the reaction is terminated by heating the solution to 70° C. and immediately cooling or diluting with an equal volume of 90° C. water and heating to 70° C.

The protein content of the solution is adjusted to 3.7% then cooled until the temperature is less than 10° C. and diafiltered (4 volume changes) then ultrafiltered to concentrate. Diafiltration serves to remove the low molecular weight (LMW) fraction from the trasnglutaminase sodium caseinate. The LMW material is the major source of unwanted flavours and salts and contains peptides, lactose etc.

MP1

The ultrafiltered cross-linked solution may be further concentrated then spray-dried.

MP2

MP1 (the caseinate form) is used as the substrate to manufacture MP2.

0.1N HCL is added to the warmed colloidal suspension (10 to 40° C. 10% TS) until a floc forms at pH 4.5 (the isoelectric point). This floc (or coagulum or curd) is pumped as is to the atomiser of a spray drier and moisture removed to give a final moisture content of approx 4% in the fine white powder, This material has a very low bulk density.

### Example 11

MP4, MP5 and MP6-Flavour Enhanced Acid Casein

MP4, MP5 and MP6 are produced from standard lactic acid casein. The separation of curd from milk may be effected according to known processes.

The isolated curd is converted into a colloidal suspension using a colloid mill the pH adjusted to 7.5 and heated to 50° C. with agitation to solubilise the curd.

The caseinate solution is diafiltered (4-6 volume changes) the pH adjusted to 4.6 and dried. MP4 can be either ring dried or spray dried then attrition or jet milled until a particle size diameter of sub 10 μm is achieved. MP5 is spray dried with a desired particle size of sub 50 μm. MP6 is ring dried and fits the 80 mesh specification (99% less than 180 μm).

The flavour reduction steps are not essential for the textural properties in the gum but can be very important for contributing to a neutral flavoured base.

### Example 12

Preparation of MP3

Enzymatically hydrolysed casein, with a degree of hydrolysis of approximately 9% of the total number of the peptide bonds, was selected as the starting material. The hydrolysed casein (7.5% weight/volume) was dispersed in water, the pH was then adjusted to 7.0 and transglutaminase (6.5 units/g casein, Activa MP, Ajinomoto), was added to the solution. The solution was stirred and incubated at 37° C. and after 48 hours the reaction was terminated by heating the solution to 70° C. The solution was diafiltered (4 theoretical volume changes), concentrated by ultrafiltration to 15% protein and spray dried.

MP3 made in this way was used in the formulations of example 5 and 8.

### Example 13

Method for Gum Manufacture

| | |
|---|---|
| Gum BaseIngredient | % (weight/weight) |

| | | |
|---|---|---|
| Polyvinyl acetate (about 12 kDa) | 14.36 | 14.36 |
| Polyvinyl acetate (about 14 kDa) | 7.66 | 7.66 |
| Polyvinyl acetate (about 25 kDa) | 12.28 | 12.28 |
| Polyvinyl acetate (about 40 kDa | 13.82 | 13.82 |
| Talc | 14.20 | 12.65 |
| Carageenan | 0.72 | 0.72 |
| Datem | 3.10 | 3.10 |
| Acetylated monoglycerides | 2.12 | 2.12 |
| Calcium stearoyl lactate | 0.26 | 0.26 |
| Calcium chloride | 0.51 | 0.51 |
| Lecithin | 1.90 | 1.90 |
| Sugar ester | 6.98 | 6.98 |
| Parafin wax | 0.94 | 0.94 |
| Stearic acid | 1.09 | 1.09 |
| Antioxidant | 0.03 | 0.03 |
| Polyvinyl acetate (70 kDa) | 1.71 | 1.71 |
| Triacetin | 5.95 | 5.95 |
| Polycasein 5 (MP's 1, 2, 4, 5 and 6) | 12.37 | 14.22 |
| | 100.0 | 100.0 |

The gum bases were produced by the following low shear method.

| | |
|---|---|
| Mixer speed: | 25 RPM |
| Oil bath temperature: | 110° C. |
| Mixing time: | 40 minutes |

At 0 minutes Datem, Acetylated monoglycerides, calcium stearoyl lactate, paraffin, stearic acid and BHA were added to the mixer.

At 1 minute the PVAC's, ½ of the talc and triacetin were added to the mixer.

At 6 minutes the remaining talc was added.

At 15 minutes the sugar ester and lecithin were added to the mixer.

At 20 minutes decrease the oil bath temperature to 60° C. and Finesse 5 was added.

At 40 minutes the gum base was removed from the mixer and rolled into a flat sheet. The gum base was stored in a vacuum-sealed foil bag until required for gum manufacture.

2. Chewing Gum

| Ingredient | % (weight/weight) |
|---|---|
| Gum base | 33.94 |
| Maltitol syrup | 15.46 |
| Mannitol (powder) | 7.39 |
| sorbitol (powder) | 41.63 |
| Flavour | 1.41 |
| Acesulfame K | 0.17 |
| | 100.00 |

The chewing gums were produced by the following low shear process.

| | |
|---|---|
| Mixer speed: | 25 RPM |
| Oil bath temperature: | 45° C. |
| Mixing time: | 20 minutes |

At 0 minutes the gum base, maltitol syrup, and mannitol were added to the mixer.

At 6 minutes the powdered ⅓ sorbitol and Acesulfame K were added.

At 7 minutes ⅓ of the sorbitol and peppermint flavour were added.

At 10 minutes ⅓ of the sorbitol was added.

At 20 minutes the chewing gum was removed from the mixer and rolled into a sheet and stored in a vacuum-sealed foil bag.

The chewing gums were chewed by one assessor and followed the same criteria as the first comparative example 8.

Results

| | Rating out of ten | | | | | |
|---|---|---|---|---|---|---|
| Casein | after minutes chewed | | | | Degree of | % Loss on |
| composition | 0 to 1 | 1 to 5 | 5 to 10 | 10 to 20 | Smoothness* | Chewing |
| Polycasein | 9.0 | 7.3 | 8.0 | 8.0 | 4.8 | 36.6 |
| 5 at 12.37% | | | | | | |
| Polycasein | 9.5 | 7.5 | 8.3 | 8.7 | 4.6 | 43.3 |
| 5 at 14.22% | | | | | | |

The use of a sugar ester (Er-290) in place of polyglycerol polyricinoleate had a large negative impact on the chewing qualities of the resulting gum; the gum became soft, spongy and lacked a “chewing gum-like chew”. Increasing the level of Polycasein 5 from 12.37% to 14.22% resulted in a decrease in the spongy character and a slight increase in the level of rubberiness and firmness. The 14.22% Polycasein 5 gum was chewing very well at 20 minutes.

### INDUSTRIAL APPLICATION

Chewing gums according to the invention, at least in the preferred embodiments, have a combination of desirable properties. The polycasein blend employed in the composition gives the resultant gums good mouth feel (neither sticky, nor slimy or fatty), good cohesion—the gum does not break into pieces on chewing but remains as one cud, exhibits good texture and firmness on chewing, with no significant tack.

The flavour of the gum composition is also improved by the removal of volatile components and low molecular weight materials, leading to off flavours in the gums.

In addition, the chewing gums remain disintegrable and are made of substantially biodegradable components.

The processes according to the invention provide for production of casein products with the desirable properties identified above. Casein products with smaller particle size than is customary, and with higher levels of purity are also produced.

It will be appreciated that the above description is provided by way of example only and numerous variations and modifications will be apparent to those persons skilled in the art without departing from the scope of the invention.

1. A gum base composition comprising a polycasein blend comprising at least four casein products selected from:
(a) transglutaminase treated non-gelled sodium caseinate;
(b) transglutaminase treated non-gelled isoelectric acid casein;
(c) transglutaminase treated, hydrolysed sodium caseinate;
(d) ultra fine mesh acid casein;
(e) fine mesh acid casein; and
(f) standard mesh acid casein.

2. A composition according to claim 1 wherein the polycasein blend comprises four to six of casein products (a) to (f).

3. A composition according to claim 1 wherein one of the casein products is (f).

4. A composition according to claim 1 wherein one of the casein products is (b).

5. A composition according to claim 1 wherein one of the casein products is (e).

6. A composition according claim 1 wherein each casein product is present in an amount of from about 10% to 40% by weight of the polycasein blend.

7. A composition according to claim 1 wherein the polycasein blend comprises the four casein products (a), (b), (d) and (f).

8. A composition according to claim 7 wherein casein products (a), (b), (d) and (f) are present in amounts from about 3 to 25%, 10 to 30%, 13 to 35% and 13 to 35% by weight of the blend respectively.

9. A composition according to claim 8 wherein casein products (a), (b), (d) and (f) are present in amounts of about 15%, 25%, 30%, and 30% respectively.

10. A composition according to claim 1 wherein the polycasein blend comprises the four casein products (a), (d), (e) and (f).

11. A composition according to claim 10 wherein the casein products (a), (d), (e) and (f) are present in amounts from about 5 to 30%, 13 to 35%, 5 to 35% and 13 to 45% by weight of the blend respectively.

12. A composition according to claim 11 wherein the casein products (a), (d), (e) and (f) are present in amounts of about 25%, 20%, 20% and 35% respectively.

13. A composition according to claim 1 wherein the polycasein blend comprises five of casein products (a) to (f).

14. A composition according to claim 13 wherein the polycasein blend comprises the five casein products (a), (b), (d), (e) and (f).

15. A composition according to claim 14 wherein casein products:
(a) and (b) are present in amounts from about 15 to 25%;
(d) and (f) are present in an amount of from about 12% to 22%; and
(e) is present in an amount of from about 20% to 30%.

16. A composition according to claim 1 wherein the polycasein blend comprises the six casein products (a), (b), (c), (d), (e) and (f).

17. A composition according to claim 16 wherein the casein products are present in amounts of from about 5 to 25%, 10 to 30%, 2 to 15%, 13 to 35%, 5 to 35% and 13 to 45% by weight of the blend respectively.

18. A composition according to claim 17 wherein the casein products are present in amounts of about 15%, 20%, 5%, 17.5%, 25% and 17.5% respectively.

19. A composition according to claim 1 wherein the polycasein blend comprises about 5 to 30% by weight of the gum base composition.

20. A composition according to claim 19 wherein the polycasein blend comprises about 11 to 15% by weight of the gum base composition.

21. A composition according to claim 1 further comprising a blend of two to five polyvinylacetates having differing molecular weights.

22. A composition according to claim 21 wherein the blend of polyvinyl acetates comprises five polyvinyl acetates having molecular weights of approximately (1) 12,900, (2) 14,000, (3) 25,000, (4) 40,000 and (5) 83,000 respectively.

23. A composition according to claim 22 wherein each polyvinylacetate is present in an amount of from 1 to 20% by weight of the gum base composition.

24. A composition according to claim 23 wherein each polyvinylacetate is present in an amount of (1) up to about 25%; (2) up to about 25%; (3) about 18-25%; (4) about 5 to 18%; (5) about 1 to 5% by weight of the gum base composition.

25. A composition according to claim 1 which further comprises one or more non-toxic plasticisers and/or emulsifiers.

26. A composition according to claim 25 wherein the plasticisers and/or emulsifiers are selected from the group consisting of mono- and di-glycerides esterfied with mono-acetyl and di-acetyl tartaric acid (DATEM) in an amount of from about 1 to 24% by weight of the composition, acetylated mono- and/or diglycerides in an amount of up to about 24% by weight of the composition, polyglycerol polyricinoleate in an amount of from about 4.4% to 20% by weight of the composition, one or more sugar esters in an amount from about 4.4 to 20% by weight of the composition, and mixtures thereof.

27. A composition according to claim 26 which further comprises the additional emulsifiers lecithin in an amount of up to 6% by weight of the composition, and sodium stearoyl-2 lactate or calcium stearoyl-2 lactate in an amount of up to about 5% by weight of the composition.

28. A composition according to claim 1 which further comprises a texturiser in an amount from about 0.05 to 3.0% by weight of the composition.

29. A composition according to claim 28 wherein the texturiser is calcium chloride.

30. A composition according to claim 1 which further comprises a filler in an amount of up to about 25% by weight of the composition.

31. A composition according to claim 30 wherein the filler is talc.

32. A chewing gum comprising a gum base composition according to claims 1.

33. A chewing gum according to claim 32 wherein the gum base composition is present in an amount of from about 20% to 90% by weight of the chewing gum.

34. A chewing gum according to claim 32 which further comprises glycerol triacetate (Triacetin) in an amount of from about 0.5 to 4% by weight of the chewing gum and/or stearic acid in an amount of from about 0.2% to 1.5% by weight of the chewing gum.

35. A chewing gum according to claim 34 which further comprises one or more sweeteners and/or flavouring agents.

36. A chewing gum according to claim 32 which is removable from a surface to which it is adhered.

37. A confectionary product comprising a gum base composition according to claim 1.

38. A method for producing transglutaminase treated sodium caseinate and/or acid casein, the method comprising:
(1) solubilising curd to produce a caseinate;
(2) heating the caseinate;
(3) incubating the caseinate at from ambient temperature up to about 55° C. with transglutaminase;
(4) quenching the transglutaminase reaction at about 55° C. to about 70° C., or with a volume of water sufficient to achieve a quench temperature of about 50° C. to about 80° C., the water being at about 50° C. to 100° C.; and;
(5) drying.

39. A method according to claim 38 wherein the pH of the quenched caseinate is adjusted to its isoelectric point of pH 4.6 before drying.

40. A method according to claim 38 wherein the quenched caseinate is diafiltered.

41. A method according to claim 40 wherein the diafiltered caseinate is ultrafiltered.

42. Transglutaminase treated sodium caseinate and/or acid casein when produced by a method of claim 38.
